(19) United States
(12) Patent Application Publication
(10) Pub. No.: US 2011/0159222 A1
(43) Pub. Date: Jun. 30, 2011

(54) FLUOROCARBON THERMOPLASTIC MATERIALS CURED WITH ORGANIC PRIMARY AMINES

(76) Inventors: Jiann-Hsing Chen, Fairport, NY (US); Jerry A. Pickering, Hilton New York, NY (US); Robert A. Lancaster, Hilton, NY (US); Nataly Boulatnikov, Rochester, NY (US)

(21) Appl. No.: 12/647,575

(22) Filed: Dec. 28, 2009

(51) Int. Cl. C08F 214/26; B32B 1/08; B32B 27/00

(52) U.S. Cl. 428/36.91; 525/326.2; 428/421; 428/339; 428/215

(57) ABSTRACT

A composition comprising a fluorocarbon thermoplastic random copolymer having the subunits of:

—(CH₂CF₂)x-, —(CF₂CF(CF₃))y-, and —(CF₂CF₂)z-,

wherein x is from 1 to 40 or 60 to 80 mole percent, z is greater than 40 to no more than 89 mole percent, and y is such that x+y+z equals 100 mole percent; wherein the fluorocarbon thermoplastic random copolymer is crosslinked with an organic primary amine. The composition may be formed by curing an aqueous coated composition of the fluorocarbon thermoplastic random copolymer and a water soluble organic primary amine, such as triethylenetetraamine (TETA). A fuser member comprises a substrate having an outer substrate surface, and an outer layer disposed over the outer substrate surface where the outer layer comprises such a composition.

### CROSS-REFERENCE TO RELATED APPLICATIONS

This application relates to commonly assigned, co-pending applications U.S. Ser. No. ______ (Doc. #95826) “FUSER MEMBER WITH FLUOROPOLYMER OUTER LAYER” and U.S. Ser. No. ______ (Doc. #95827) “METHOD OF MAKING FUSER MEMBER” filed simultaneously herewith.

### FIELD OF THE INVENTION

This invention relates to fluorocarbon thermoplastic materials cured with organic primary amines, and more particularly to aqueous coated fluorocarbon thermoplastic materials cured with water soluble organic primary amines as a toner release layer in a fuser member useful for heat-fixing a heat-softenable toner material to a substrate.

### BACKGROUND OF THE INVENTION

Heat-softenable toners are widely used in imaging methods such as electrostatography, wherein electrically charged toner is deposited imagewise on a dielectric or photoconductive element bearing an electrostatic latent image. Most often in such methods, the toner is then transferred to a surface of another substrate, such as, e.g., a receiver sheet comprising paper or a transparent film, where it is then fixed in place to yield the final desired toner image.

When heat-softenable toners, comprising, e.g., thermoplastic polymeric binders, are employed, the usual method of fixing the toner in place involves applying heat to the toner once it is on the receiver sheet surface to soften it and then allowing or causing the toner to cool.

One such well-known fusing method comprises passing the toner-bearing receiver sheet through the nip formed by a pair of opposing rolls, at least one of which (usually referred to as a fuser roll) is heated and contacts the toner-bearing surface of the receiver sheet in order to heat and soften the toner. The other roll (usually referred to as a pressure roll) serves to press the receiver sheet into contact with the fuser roll. In some other fusing methods, the configuration is varied and the “fuser roll” or “pressure roll” takes the form of a flat plate or belt. The description herein, while generally described in the context of a generally cylindrical fuser roll in combination with a generally cylindrical pressure roll, is not limited to fusing systems having members with those configurations. For that reason, the term “fuser member” is generally used herein in place of “fuser roll” and the term “pressure member” in place of “pressure roll.”

The fuser member may comprise a rigid support covered with a resilient material, which will be referred to herein as a “base cushion layer.” The resilient base cushion layer and the amount of pressure exerted by the pressure member serve to establish the area of contact of the fuser member with the toner-bearing surface of the receiver sheet as it passes through the nip of the fuser member and pressure members. The size of this area of contact helps to establish the length of time that any given portion of the toner image will be in contact with and heated by the fuser member. The degree of hardness (often referred to as “storage modulus”) and stability thereof, of the base cushion layer are important factors in establishing and maintaining the desired area of contact.

In some previous fusing systems, it has been advantageous to vary the pressure exerted by the pressure member against the receiver sheet and fuser member. This variation in pressure can be provided, for example in a fusing system having a pressure roll and a fuser roll, by slightly modifying the shape of the pressure roll. The variance of pressure, in the form of a gradient of pressure that changes along the direction through the nip that is parallel to the axes of the rolls, can be established, for example, by continuously varying the overall diameter of the pressure roll along the direction of its axis such that the diameter is smallest at the midpoint of the axis and largest at the ends of the axis, in order to give the pressure roll a sort of “bow tie” or “hourglass” shape. This will cause the pair of rolls to exert more pressure on the receiver sheet in the nip in the areas near the ends of the rolls than in the area about the midpoint of the rolls. This gradient of pressure helps to prevent wrinkles and cockle in the receiver sheet as it passes through the nip. Over time, however, the fuser roll begins to permanently deform to conform to the shape of the pressure roll and the gradient of pressure is reduced or lost, along with its attendant benefits. It has been found that permanent deformation (alternatively referred to as “creep”) of the base cushion layer of the fuser member is the greatest contributor to this problem.

Particulate inorganic fillers have been added to base cushion layers to improve mechanical strength and thermal conductivity. High thermal conductivity is advantageous when the fuser member is heated by an internal heater, so that the heat can be efficiently and quickly transmitted toward the outer surface of the fuser member and toward the toner on the receiver sheet it is intended to contact and fuse. High thermal conductivity is not so important when the roll is intended to be heated by an external heat source.

Polyfluocarbon elastomers, such as vinylidene fluoride-hexafluoropropylene copolymers, are tough, wear resistant and flexible elastomers that have excellent high temperature resistance, but relatively high surface energies, which compromises toner release.

Fluorocarbon resins like polytetrafluoroethylene (PTFE) or fluorinated ethylenepropylene (FEP) are fluorocarbon plastics which have excellent release characteristics due to very low surface energy. Fluorocarbon resins are, however, less flexible and elastic than fluorocarbon elastomers and are therefore not suitable alone as the surface of the fuser roller.

U.S. Pat. No. 4,568,275 discloses a fuser roll having a layer of fluorocarbon elastomer and a fluorinated resin powder. However, the fluorocarbon elastomer that is disclosed is water dispersible and it is known that the mixture phase separates on coating so that the fluorinated resin that is used comes to the surface of the layer.

U.S. Pat. No. 5,253,027 discloses a fluorinated resin in a silicone elastomer. However, composites of this type exhibit unacceptable swell in the presence of silicone release oil.

U.S. Pat. No. 5,599,631 discloses a fuser roll having a layer of a fluorocarbon elastomer and a fluorocarbon resin. The drawback of this type of material is that the fluorocarbon resin powder tends to phase separate from the fluorocarbon elastomer thereby diminishing toner release.

U.S. Pat. No. 4,853,737 discloses a fuser roll having an outer layer comprising cured fluorocarbon elastomers containing pendant amine functional polydimethylsiloxane that are covalently bonded to the backbone of the fluorocarbon elastomer. However, the amine functional polydimethylsiloxane tends to phase separate from the fluorocarbon elastomer.

U.S. Pat. No. 5,582,917 discloses a fuser roll having a surface layer comprising a fluorocarbon-silicone polymeric composition obtained by heating a fluorocarbon elastomer with a fluorocarbon elastomer curing agent in the presence of a curable polyfunctional poly(C1-6 alkyl) siloxane polymer. However, the resulting interpenetrating network (IPN) has relatively high coefficient of friction and relatively low mechanical strength. After a period of use, the release property of the roller degrades and paper jams begin to occur.

U.S. Pat. No. 5,547,759 discloses a fuser roll having a release coating layer comprising an outermost layer of fluorocarbon resin uniquely bonded to a fluoroelastomer layer by means of a fluoropolymer containing a polyamide-imide primer layer. Although the release coating layer has relatively low surface energy and good mechanical strength the release coating layer lacks flexibility and elastic properties and can not produce high quality of images. In addition, sintering the fluorocarbon resin layer is usually accomplished by heating the coated fuser member to temperatures of approximately 350° C. to 400° C. Such high temperatures can have a detrimental effect on the underlying base cushion layer which normally comprises a silicone rubber layer. It would be desirable to provide a fuser member with an overcoat layer comprising a fluorocarbon resin layer without depolymerizing the silicone base cushion layer.

Polysiloxane elastomers have relatively high surface energy and relatively low mechanical strength, but are adequately flexible and elastic and can produce high quality fused images. After a period of use, however, the self release property of the roller degrades and offset begins to occur. Application of a polysiloxane fluid during roller use enhances the ability of the roller to release toner, but shortens roller life due to oil absorption. Oiled portions tend to swell and wear and degrade faster.

One type of material that has been widely employed in the past to form a resilient base cushion layer for fuser rolls is a condensation-crosslinked siloxane elastomer. Disclosure of filled condensation-cured poly(dimethylsiloxane) “PDMS’ elastomers for fuser rolls can be found, for example, in U.S. Pat. Nos. 4,373,239; 4,430,406; and 4,518,655. U.S. Pat. No. 4,970,098 to Ayala-Esquillin et al. teaches a condensation cross-linked diphenylsiloxane-dimethylsiloxane elastomer having 40 to 55 weight percent zinc oxide, 5 to 10 weight percent graphite, and 1 to 5 weight percent ceric dioxide.

A widely used siloxane elastomer is a condensation-crosslinked PDMS elastomer, which contains about 32-37 volume percent aluminum oxide filler and about 2-6 volume percent iron oxide filler, and is sold under the trade name, EC4952, by the Emerson Cummings Co., U.S.A. It has been found that fuser rolls containing EC4952 cushion layers exhibit serious stability problems over time of use, i.e., significant degradation, creep, and changes in hardness, that greatly reduce their useful life. Nevertheless, materials such as EC4952 initially provide very suitable resilience, hardness, and thermal conductivity for fuser roll cushion layers.

U.S. Pat. No. 5,595,823 discloses toner fusing members which have a substrate coated with a fluorocarbon random copolymer containing aluminum oxide. Although these toner fusing members have proved effective and have desirable thermal conductivity, they have a problem in that there can be toner contamination.

U.S. Pat. Nos. 6,444,741; 6,429,249; 6,696,158; and 6,361,829 describe fuser members and methods of making fuser members wherein the fuser member comprises a fluorocarbon thermoplastic random copolymer resin, wherein the method employs a bisphenol curing agent and an aminosiloxane, and requires extended preparation time, use of organic solvent, and use of metal oxide filler as acid acceptor. An advantage of using cured fluorocarbon thermoplastic random copolymer compositions is that they are effective for use with toner release agents which typically include silicone. A problem with such fuser members, however, is that both the bisphenol curing agent and the aminosiloxane are not water soluble and they need to be dissolved into an organic solvent such as methyl ethyl ketone. In addition, the fluorocarbon thermoplastic random copolymer resin solution needed to be cured at 275 C for few hours which may be detrimental to the underneath base cushion layer. The use of metal oxide filler as acid acceptor further may harden the fluorocarbon thermoplastic random copolymer resin layer, and increase toner contamination when used as fusing member overcoat. Such references further mention DIAK No. 1 and DIAK No. 3 as possible curing agents, but both DIAK No. 1 (hexamethylene diamine carbmate) and DIAK No. 3 (bis(cinnamylidene) hexamethylenediamine) are blocked amines (see, e.g., Maurice Morton, Rubber Technology, 3^{rd} Edition, Chapter 14, page 413). Blocked amine systems similarly require the presence of metal oxide to obtain product with practical cured time up to 24 hours at temperatures of 200 C and above to develop optimum physical property.

It has been extremely difficult to provide aqueous coatable and low temperature curable materials for a fuser roller with, at the same time, good wear resistance, good release property, low coefficient of friction and low oil swell when exposed to release oil.

### SUMMARY OF THE INVENTION

It would be desirable to provide a water based fluorocarbon thermoplastic random copolymer which exhibits low temperature cured property and without the need for zinc oxide filler and an amino-functional polysiloxane polymer to have a good mechanical strength and low toner contamination.

It is an object of the invention to provide aqueous coatable materials for forming a toner release layer.

It is another object of the present invention to provide a fuser member that contains an aqueous coated fluorocarbon thermoplastic random copolymer having desired toner release and mechanical strength properties.

In accordance with one embodiment, the invention is directed towards a composition comprising a fluorocarbon thermoplastic random copolymer having the subunits of:

—(CH₂CF₂)x-, —(CF₂CF(CF₃))y-, and —(CF₂CF₂)z-,

wherein x is from 1 to 40 or 60 to 80 mole percent, z is greater than 40 to no more than 89 mole percent, and y is such that x+y+z equals 100 mole percent, wherein the fluorocarbon thermoplastic random copolymer is crosslinked with an organic primary amine. In accordance with a further embodiment, the invention is directed towards a fuser member comprising a substrate comprising an outer substrate surface, and an outer layer disposed over the outer substrate surface comprising such a composition. The composition may advantageously be formed by curing an aqueous coated composition of the fluorocarbon thermoplastic random copolymer and a water soluble organic primary amine.

### BRIEF DESCRIPTION OF THE DRAWINGS

FIG. 1 is a cross-sectional view of a fusing member in accordance with an embodiment of the present invention.

### DETAILED DESCRIPTION OF PARTICULAR EMBODIMENTS

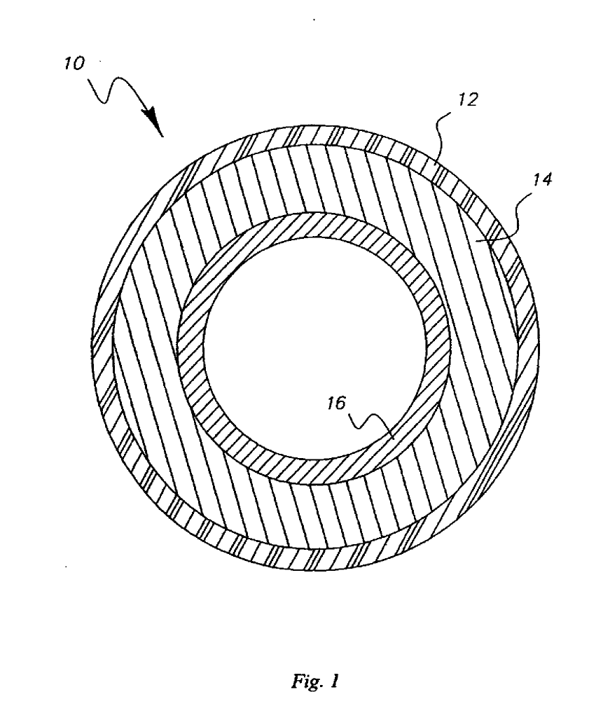

FIG. 1 shows a cross-sectional view of a fuser member 10 which includes fuser roller, pressure roller, oiler donor roller, oiler metering roller, pre-conditioning roller, etc. The support 16 is usually metallic such as stainless steel, steel, aluminum, etc.; however, the support 16 may also be made of a ceramic or plastic. The primary requisites for support 16 materials are that it provide the necessary stiffness, be able to support the force placed upon it, and be able to withstand whatever temperature to which it is subjected. Disposed above the support 16 lies one or more optional intermediate layers 14 which may be characterized in the art as cushion layers. The outermost layer 12 is a toner release layer. In the event that a cushion layer 14 is not desired, then the outermost layer 12 is disposed directly over the support 16. The outermost layer 12 is an aqueous coated layer, it includes a cross-linked fluorocarbon random copolymer that is cured by an aqueous soluble curing agent.

The fluorocarbon random copolymer has subunits of:

—(CH₂CF₂)x-, —(CF₂CF(CF₃)y-, and —(CF₂CF₂)z-,

wherein

x is from 1 to 40 or 60 to 80 mole percent,

y is from 10 to 90 mole percent,

z is from 10 to 90 mole percent, and

x+y+z equals 100 mole percent.

In the above Formula, —(CH₂CF₂)— represents a vinylidene fluoride subunit (“VF₂”), —(CF₂CF(CF₃)— represents a hexefluoropropykene subunit (“HFP”), and —(CF₂CF₂)— represents a tetrafluoroethylene subunit (“TFE”).

In accordance with the present invention, the curing agent used to cross-link the fluorocarbon random copolymer comprises an aqueous soluble organic primary amine compound. Such compounds may be organic mono, di- or higher-amine compounds having a molecular weight of less than 300 dalton, more typically less than 200 dalton, and preferably are organic di-, tri- or higher amine compounds and most preferably organic tetraamine compounds. Examples of such aqueous soluble organic primary amine compounds include primary amines having from one to six carbon atoms (C₁ to C₆), such as methylamine, ethylenediamine, trimethylenediamine, tetramethylenediamine, hexamethylenediamine, triethylenetetramine, etc. Triethylenetetraamine (TETA) has been found to be particularly effective in accordance with a specific example of the present invention.

While the previously proposed use of a fluorocarbon thermoplastic random copolymer resins employing a bisphenol curing agent, an aminosiloxane, and metal oxide filler as acid acceptor employ a basic nucleophilic cure system requiring use of an organic solvent for such materials and relatively high cure temperatures, the present invention materials employing water soluble organic primary amines are cured by first dehydrogenation of the fluorocarbon thermoplastic random copolymer and then by addition reaction of amine function group with the double bond created by dehydrogenation, and enable curing in aqueous systems at relatively lower cure temperatures (e.g., less than 200° C., and preferable from 150° C. to 199° C.). The water soluble organic primary amine compounds employed in the present invention are further distinguished from the amino functional polydimethyl siloxane copolymers employed in the prior art in that such typically higher molecular weight aminofunctional polydimethyl siloxane copolymers comprise inorganic siloxane chains and are not water soluble. The compositions and fuser member layer of the present invention may accordingly be characterized as in the substantial absence of bisphenol curing agent, aminosiloxanes, and metal oxide filler acid acceptor as employed in the prior art.

It is a feature of one embodiment of the present invention that a fuser member formed with a toner release layer that includes an aqueous coated cross-linked polyfluorocarbon thermoplastic random copolymer which has a moderately low surface energy and that by using a fluorocarbon thermoplastic polymeric composition an improved fuser member is provided.

In the above formulas, x, y, and z are mole percentages of the individual subunits relative to a total of the three subunits (x+y+z), referred to herein as “subunit mole percentages” (The curing agent can be considered to provide an additional “cure-site subunit,” however, the contribution of these cure-site subunits is not considered in subunit mole percentages.) In the fluorocarbon thermoplastic copolymer, x has a subunit mole percentage of from 1 to 40 or 60 to 80 mole percent, y has a subunit mole percentage of from 10 to 90 mole percent, and z has a subunit mole percentage of from 10 to 90 mole percent. In a currently preferred embodiment of the invention, subunit mole percentages are: x is from 30 to 40 or 70 to 80, y is from 10 to 60, arid z is from 5 to 30; or more preferably x is from 35 to 40, y is from 40 to 58, and z is 5 to 10. In the currently preferred embodiments of the invention, x, y, and z are selected such that fluorine atoms represent at least 75 percent of the total formula weight of the VF₂, HFP, and TFE subunits.

Preferred composites of the invention have a ratio of organic primary amine to fluorocarbon thermoplastic random copolymer between about 1 and to 10 by parts of per hundred parts of fluorocarbon thermoplastic random copolymer, preferably between about 2 and 5 parts of per hundred parts of fluorocarbon thermoplastic random copolymer. The composite is preferably obtained by curing a mixture of a fluorocarbon thermoplastic copolymer and from 1-5 parts of organic primary amine curing agent per hundred parts of fluorocarbon thermoplastic random copolymer. Additional materials may optionally be added, such as a fluorinated resin release aid filler.

Typically, fluorocarbon elastomer coating compositions are dried until solvent free at room temperature, then gradually heated to about 230° C. over 24 hours, then maintained at that temperature for 24 hours. By contrast, the cure of the aqueous coated fluorocarbon thermoplastic random copolymer compositions of the current invention may be performed at substantially lower temperatures and shorter times, e.g., 2 to 10 hours, preferably 2-4 hours, at a temperature of less than 200° C., preferably 150° C. to 199° C.

To form the outer layer, the uncured fluorocarbon thermoplastic random copolymer is mixed with an aqueous soluble organic primary amine curing agent, and any other additives, such as fluorinated resin; coated over the base cushion, and cured. The fluorocarbon thermoplastic random copolymer is cured by first dehydrogenation of the fluorocarbon thermoplastic random copolymer and then by addition reaction of amine function group with the double bond created by dehydrogenation. The crosslinker is incorporated into the polymer as a cure-site subunit. The fluorinated resins which include polyterafluoroethylene (PTFE) or Fluoethylenepropylene (FEP) are commercially available from duPont.

Suitable fluorocarbon thermoplastic random copolymers are available commercially. In a particular embodiment of the invention, a vinylidene fluoride-co-tetrafluoroethylene co-hexafluoropropylene was used which can be represented as -(VF)(75)-(TFE)(10)-(HFP)25)-. This material is marketed by Hoechst Company under the designation ‘THV Fluoroplastics” and is referred to herein as “THV.” In another embodiment of the invention, a vinylidene fluoride-co-tetrafluoroethylene-co-hexafluoropropylene was used which can be represented as -(VF)(42)-(TFE)(10)-(HFP)(58)-. This material is marketed by Minnesota Mining and Manufacturing, St. Paul, Minn., under the designation “3M THV” and is referred to herein as “THV-200”. Other suitable uncured vinylidene fluoride-cohexafluoropropylenes and vinylidene fluoride-co-tetrafluoroethylene-cohexafluoropropylenes are available, for example, THV-400, THV-500 and THV-300.

In general, THV Fluoroplastics are set apart from other melt-processable fluoroplastics by a combination of high flexibility and low process temperature. With flexural modulus values between 83 Mpa and 207 Mpa, THV Fluoroplastics are the most flexible of the fluoroplastics.

The molecular weight of the uncured polymer is largely a matter of convenience, however, an excessively large or excessively small molecular weight would create problems, the nature of which are well known to those skilled in the art. In a preferred embodiment of the invention the uncured polymer has a number average molecular weight in the range of about 100,000 to 200,000.

The fuser member may be constructed forming a toner release layer on an optional base cushion provided on a support comprising the steps of:

(a) providing a support, optionally having a base cushion layer thereon;

(b) providing an aqueous mixture having:
(i) a fluorocarbon thermoplastics random copolymer having subunits of:

—(CH₂CF₂)x-, —(CF₂CF(CF₃)y-, and —(CF₂CF₂)z-,

wherein

x is from 1 to 40 or 60 to 80 mole percent,

y is from 10 to 90 mole percent,

z is from 10 to 90 mole percent,

x+y+z equals 100 mole percent; and
(ii) an aqueous soluble organic primary amine; and

(c) applying the mixture to the base cushion layer or directly over the support, and curing the applied mixture to crosslink the fluorocarbon thermoplastic random copolymer.

In cases where it is intended that the fuser member be heated by an internal heater, it is desirable that the outer layer have a relatively high thermal conductivity, so that the heat can be efficiently and quickly transmitted toward the outer surface of the fuser member that will contact the toner intended to be fused. (Depending upon relative thickness, it is generally even more desirable that the base cushion layer and any other intervening layers have a relatively high thermal conductivity. Suitable materials for the base cushion layer are discussed below).

Some fusing systems use a release oil, such as a PDMS oil, to prevent offset, that is, to aid the roll in releasing from the toner it contacts during the fusing operation. During use, the oil is continuously coated over the surface of the fuser member in contact with the toner image. The fuser member of the invention can be used with polydimethylsiloxane, amino functionalized polydimethylsiloxane or mercapto functionalized polydimethylsiloxane release oils at normally used application rates or at reduced application rates, from about 0.5 mg/copy to 10 mg/copy (the copy is 8.5 by 11 inch 20 pound bond paper).

The outer layer of the fuser member of the invention is substantially resistant to release oil induced swelling. In a preferred embodiment of the invention, the change in size due to swelling is less than 0.1 to 1.0 percent. In an even more preferred embodiment of the invention, the change in size due to swelling is less than 0.01 to 0.1 percent.

The thickness of the optional base cushion layer and the outer layer and the composition of the base cushion layer can be chosen so that the base cushion layer can provide the desired resilience to the fuser member, and the outer layer can flex to conform to that resilience. The thickness of the base cushion and outer layers will be chosen with consideration of the requirements of the particular application intended. Usually, the outer layer would be thinner than the base cushion layer. For example, base cushion layer thicknesses in the range from 0.6 to 5.0 mm have been found to be appropriate for various applications. In some embodiments of the present invention, the base cushion layer is about 2.5 mm thick, and the outer layer is from about 25 to 30 micrometers thick.

Suitable materials for the base cushion layer include any of a wide variety of materials previously used for base cushion layers, such as the condensation cured polydimethylsiloxane marketed as EC4952 by Emerson Curning. An example of a condensation cured silicon rubber base cushion layer is GE 4044 marketed by General Electric of Waterford, N.Y. An example of an addition cured silicone rubber is Silastic J RTV marketed by Dow Coming applied over a silane primer DC-1200 also marketed by Dow Coming.

In a particular embodiment, the base cushion is resistant to cyclic stress induced deformation and hardening. Examples of suitable materials to reduce cyclic stress induced deformation and hardening are filled condensation-crosslinked PDMS elastomers disclosed in U.S. Pat. No. 5,269,740 (copper oxide filler), U.S. Pat. No. 5,292,606 (zinc oxide filler), U.S. Pat. No. 5,292,562 (chromium oxide filler), U.S. Pat. No. 5,480,724 (tin oxide filler), U.S. Pat. No. 5,336,539 (nickel oxide filler). These materials all show reasonable thermal conductivities and much less change in hardness and creep than EC4952 or the PDMS elastomer with aluminum oxide filler. Additional suitable base cushions are disclosed in U.S. Pat. No. 5,466,533, entitled “Zinc Oxide Filled Diphenylsiloxane-Dimethylsiloxane Fuser Roll for Fixing Toner to a Substrate,” U.S. Pat. No. 5,474,852, entitled “Tin Oxide Filled Diphenylsiloxane-Dimethylsiloxane Fuser Roll for Fixing Toner to a Substrate,” U.S. Pat. No. 5,464,703, entitled “Tin Oxide Filled Dimethylsiloxane-Fluoroalkylsiloxane Fuser Roll for Fixing Toner to a Substrate.” The patents mentioned in this paragraph are hereby incorporated herein by reference.

The support of the fuser member is usually cylindrical in shape. It comprises any rigid metal or plastic substance. Metals are preferred when the fuser member is to be internally heated, because of their generally higher thermal conductivity. Suitable support materials include, e.g., aluminum, steel, various alloys, and polymeric materials such as thermoset resins, with or without fiber reinforcement. The support which has been conversion coated and primed with metal alkoxide primer in accordance with U.S. Pat. No. 5,474,821, which is hereby incorporated by reference.

The fuser member is mainly described herein in terms of embodiments in which the fuser member is a fuser roll having a support, a base cushion layer overlying the support, and an outer layer superimposed on the base cushion. The invention is not, however, limited to a roll, nor is the invention limited to a fusing member having a support bearing two layers: the base cushion layer and the outer layer. The fuser member of the invention can have a variety of outer configurations and layer arrangements known to those skilled in the art. For example, the base cushion layer could be eliminated or the outer layer described herein could be overlaid by one or more additional layers.

The invention is further illustrated by the following Examples and Comparative Examples.

### Comparative Examples 1-3

A cylindrical stainless steel support was cleaned with dichloromethane and dried. The support was then primed with a uniform coat of a metal alkoxide type primer, Dow 1200 RTV Prime Coat primer, marketed by Dow Coming Corporation of Midland, Mich.; which contains: light aliphatic petroleum naptha (85 weight percent), tetra (2-methoxyethoxy)-silane (5 weight percent), tetrapropyl orthosilicate (5 weight percent), and tetrabutyl titanate (5 weight percent). Silastic J RTV room temperature vulcanizing silicone rubber, marketed by Dow Coming Corporation of Midland, Mich.; was then mixed with catalyst and injection molded onto the support and cured at 230° C. for 2 hours under 75 tons/inch² of pressure. The roller was then removed from the mold and baked in a convection oven with a temperature ramp increasing to 230° C. substantially uniformly over 24 hours and then maintaining that temperature for an additional 24 hours. After air cooling, EC4952 marketed by Emerson Cumming Division of W. R. Grace and Co. of Connecticut was blade coated directly onto the Silastic J layer, then cured for 12 hours at about 210° C., followed by 48 hours at 218° C. in a convection oven. After air cooling, the EC4952 was ground to a thickness of 20 mils. The cured EC4952 was corona discharged for 15 minutes at 750 watts and an outer layer was applied.

Fluorocarbon thermoplastic random copolymer THV 200A, zinc oxide, and aminosiloxane DMS-A21 were mixed as indicated (amounts listed as parts per hundred) in Table 1 with varying amounts of fluorinated resin. THV200A is a commercially available fluorocarbon thermoplastics random copolymer which is sold by 3M Corporation. The zinc oxide particles can be obtained from convenient commercial source, e.g., Atlantic Equipment Engineers of Bergenfield, N.J. The amino siloxane DMS-A21 is commercially available from Gelest, Inc. The fluorinated resin which included polyterafluoroethylene (PTFE) or Fluoethylenepropylene (FEP) is commercially available from duPont. Table 1 sets forth the parts per hundred (pph) of the fluorocarbon thermoplastics random copolymer. The weight fractions of fluorocarbon thermoplastic random copolymer, zinc oxide and aminosiloxane were held constant. Each of the formulations were mixed with 3 gram of curative 50 (products made by the duPont). The formulations were all mixed on a two-roll mill then dissolved to form a 25 weight percent solids solution in methyl ethyl ketone. Part of the resulting material was ring coated onto the cured EC4952 layer, air dried for 16 hours, baked with 2.5 hour ramp to 275° C., given a 30 minutes soak at 275° C., then held 2 hours at 260° C. The Silastic J layer had a thickness of 380 mils. The resulting outer layer of fluorocarbon random copolymer had a thickness of 1 mil. The remainder of the material was cast to a film and allowed to dry for 3 days. Afterwards the cast films were baked with the same procedures described above.

### Examples 1-3

Substantially the same procedures were followed as in Comparative Example 1-3, with the following exceptions as indicated in the compositions (amounts listed as parts per hundred) listed in Table 1. Examples 1, 2 and 3 did not contain zinc oxide or aminosiloxane or Cure 50. For Examples 1 to 3, the THV-200A fluoroplastic in the Comparative Examples 1-3 was replaced with THV 340Z fluoroplastic also available from E. I. du Pont de Nemours and Co., and in Examples 1 to 3 the mixture also included the polyfunctional organic primary amine triethylenetetraamine (TETA). Triethylenetetraamine (TETA) is sold by the Aldrich Co. Milwaukee, Wis. The formulations were all mixed on a two-roll mill then dissolved to form a 25 weight percent solids solution in aqueous water solution. Part of the resulting material was ring coated onto the cured EC4952 layer, air dried for 8 hours. Example 1, 2 and 3 was cured at 175° C. for 4 hours. The resulting outer layer of fluorocarbon random copolymer had a thickness of 1 mil.

TABLE 1

| | | THV- | | | Amino- | |
|---|---|---|---|---|---|---|
| Sample | THV-340Z | 200A | TETA | ZnO | silicone | Cure 50 |
| Example 1 | 100 | 0 | 2 | 0 | 0 | 0 |
| Example 2 | 100 | 0 | 3 | 0 | 0 | 0 |
| Example 3 | 100 | 0 | 4 | 0 | 0 | 0 |
| C-Example 1 | 0 | 100 | 0 | 7 | 10 | 1 |
| C-Example 2 | 0 | 100 | 0 | 7 | 10 | 1.5 |
| C-Example 3 | 0 | 100 | 0 | 7 | 10 | 2 |

TABLE 2

| | DMA modulus | Tan δ | Dry | Dry | |
|---|---|---|---|---|---|
| Sample | 175° C., Mpa | 200° C. | offset | release | Cure Temp. |
| Example 1 | 0.8 | 0.15 | 2 | 1 | 170° C. |
| Example 2 | 1.78 | 0.08 | 2 | 2 | 170° C. |
| Example 3 | 1.77 | 0.07 | 2 | 2 | 170° C. |
| C-Example 1 | 1.0 | 0.23 | 3 | 3 | 270° C. |
| C-Example 2 | 2.0 | 0.18 | 3 | 2 | 270° C. |
| C-Example 3 | 2.5 | 0.07 | 2 | 1 | 270° C. |

### DMA: Testing Method

The samples were tested on a Rheometrics RSA II Dynamic Mechanical Analyzer (DMA) and required a sample geometry of 7.5 mm×23 mm with a thickness between 30 microns to 2000 microns. The free standing films were tested at 10 Hz and a strain of 0.07%. The test was recorded over a temperature scan of −100° C. to 200° C. Over the temperature scan an oscillatory strain is applied to the sample and the resulting stress is measured. These values are related to material properties by E′ and E″ (Storage and Loss Moduli, respectively). As a result of DMA testing, the storage modulus (E′) at three different temperatures is determined and the behavior of the material about the fusing temperature 175° C. is observed. The tan δ is the ratio of storage and loss modulus E′/E″ as measured at 200° C. respectively.

Table 2 shows a comparison between the cured fluorocarbon thermoplastic random copolymer of Example 1-3 and the cured fluorocarbon thermoplastic random copolymer of Comparative examples 1, 2 and 3. The comparative examples, despite containing the bisphenol residue curing agent, zinc oxide, and aminosiloxane did not cure completely because they have higher tan delta although contain the zinc oxide filler which acts as an acid accelerator for curing. When the tan delta equal or lower than 0.15, the cured formulation provides outer coatings for the roller, it will more readily release the receiver sheet from the roller forming the nip so that good receiver sheet flow is achieved. In terms of the modulus at the 175° C. fusing temperature, the cured fluorocarbon thermoplastic random copolymer provides a significant improvement in the lower modulus mechanical properties at the fusing temperature. The Invention Examples demonstrated both an E′ of less than 2.0 Mpa and a Tan delta of less than or equal to 0.15.

### Toner Release Test

The test samples are employed to evaluate the toner offset and release force characteristics of the fuser member coating. Two 1-inch square pieces are cut from each example. One of these squares is left untreated with release agent (the dry sample). Each sample is incubated overnight at a temperature of 175° C. Following this treatment, the surface of each sample is wiped with dichloromethane. Each sample is then soaked in dichloromethane for one hour and allowed to dry before off-line testing for toner offset and release properties.

Each sample is tested in the following manner:

A one-inch square of paper covered with unfused polyester toner is placed in contact with a sample on a bed heated to 175° C., and a pressure roller set for 80 psi is locked in place over the laminate to form a nip. After 20 minutes the roller is released from the laminate.

The extent of offset for each sample is determined by microscopic examination of the sample surface following delamination. The following numerical evaluation, corresponding to the amount of toner remaining on the surface, is employed:

| | |
|---|---|
| 1 | 0% offset |
| 2 | 1-20% offset |
| 3 | 21-50% offset |
| 4 | 51-90% offset |
| 5 | 91-100% offset |

Qualitative assessment of the force required for delamination of the samples is as follows:

| | |
|---|---|
| 1 | low release force |
| 2 | moderate release force |
| 3 | high release force |

Table 2 shows a comparison between the compositions of the invention and the comparative examples comprising a fluoroelastomer with the addition of zinc oxide. In terms of toner release and offset, the compositions of the invention show the significantly improved dry toner release and offset.

The above results show that without the combination of zinc oxide, aminosiloxane and curative 50 in conjunction with the fluorocarbon thermoplastic random copolymer still provide significant improvements in fuser member properties and performance. Positive attributes such as low curing temperature, lower modulus and lower tan delta which increased lubricity and mechanical strength are maximized while negative attributes such as propensity to offset and lack of toner release are minimized.

The invention has been described in detail with particular reference to certain preferred embodiments thereof, but it should be appreciated that variations and modifications can be effected within the scope of the invention.

1. A composition comprising a fluorocarbon thermoplastic random copolymer having the subunits of:
—(CH₂CF₂)x-, —(CF₂CF(CF₃))y-, and —(CF₂CF₂)z-,
wherein
x is from 1 to 40 or 60 to 80 mole percent,
z is greater than 40 to no more than 89 mole percent, and
y is such that x+y+z equals 100 mole percent;
wherein the fluorocarbon thermoplastic random copolymer is crosslinked with an organic primary amine.

2. The composition of claim 1, wherein the organic primary amine comprises an organic tetraamine compound.

3. The composition of claim 1, wherein the organic primary amine comprises triethylenetetraamine (TETA).

4. The composition of claim 1, formed by curing an aqueous coated composition of the fluorocarbon thermoplastic random copolymer and a water soluble organic primary amine.

5. The composition of claim 4, wherein the aqueous coated composition of the fluorocarbon thermoplastic random copolymer and a water soluble organic primary amine are cured at a temperature of less than 200° C.

6. The composition of claim 5, wherein the aqueous coated composition of the fluorocarbon thermoplastic random copolymer and a water soluble organic primary amine are cured at a temperature of from 150° C. to 199° C.

7. The composition of claim 1, having a Modulus E′ less than 2.0 Mpa and a tan delta less than or equal to 0.15.

8. A fuser member comprising:
a substrate comprising an outer substrate surface; and
an outer layer disposed over the outer substrate surface comprising a fluorocarbon thermoplastic random copolymer having the subunits of:
—(CH₂CF₂)x-, —(CF₂CF(CF₃))y-, and —(CF₂CF₂)z-,
wherein
x is from 1 to 40 or 60 to 80 mole percent,
z is greater than 40 to no more than 89 mole percent, and
y is such that x+y+z equals 100 mole percent;
wherein fluorocarbon thermoplastic random copolymer is crosslinked with an organic primary amine.

9. The fuser member of claim 8, wherein the organic primary amine comprises an organic tetraamine compound.

10. The fuser member of claim 8, wherein the organic primary amine comprises triethylenetetraamine (TETA).

11. The fuser member of claim 8, wherein the outer layer is formed by curing an aqueous coated composition of the fluorocarbon thermoplastic random copolymer and a water soluble organic primary amine.

12. The fuser member of claim 11, wherein the aqueous coated composition of the fluorocarbon thermoplastic random copolymer and a water soluble organic primary amine are cured by heating at a temperature of less than 200° C.

13. The fuser member of claim 12, wherein the aqueous coated composition of the fluorocarbon thermoplastic random copolymer and a water soluble organic primary amine are cured by heating at a temperature of from 150° C. to 199° C.

14. The fuser member of claim 8, wherein the outer layer has a Modulus E′ less than 2.0 Mpa and a tan delta less than or equal to 0.15.

15. The fuser member of claim 8, wherein the substrate comprises a rigid cylinder, a rigid plate, or a belt.

16. The fuser member of claim 8, wherein the substrate comprises a rigid cylinder.

17. The fuser member of claim 8 further comprising a resilient layer comprising an elastomer disposed between the outer substrate surface and the outer layer.

18. The fuser member of claim 17, wherein said resilient layer comprises a thickness of from 1 to 10 mm.

19. The fuser member of claim 18, wherein said outer layer comprises a thickness of from 5 to 50 microns.

20. The fuser member of claim 8, wherein said outer layer comprises a thickness of from 5 to 50 microns.
